(19) United States
(12) Patent Application Publication
(10) Pub. No.: US 2009/0138536 A1
(43) Pub. Date: May 28, 2009

(54) PRECISION-SENSING LINEAR INTERPOLATION ALGORITHM

(76) Inventors: Chih-Hao Chao, Taipei County (TW); Yen-Lin Kuo, Changhua County (TW); An-Yen Wu, Taipei City (TW)

Correspondence Address: Joe McKinney Muncy, PO Box 1364, Fairfax, VA, 22038-1364, US

(21) Appl. No.: 11/945,912

(22) Filed: Nov. 27, 2007

(51) Int. Cl. G06F 17/17

(52) U.S. Cl. 708/290

(57) ABSTRACT

The present invention discloses a precision-sensing linear interpolation algorithm, which is distinct from the conventional technology in that precision detection is performed before iterative division calculations. The iteration number of iterative division calculations is determined according to the required precision. After the iterative division calculations, the bits in the decimal places unnecessary for the required precision are set to be 0 with a bit-masking method. Via the precision detection and bit mask, the present invention can promote algorithm efficiency and reduce dynamic power consumption.

### FIELD OF THE INVENTION

The present invention relates to a linear interpolation algorithm, particularly to a precision-sensing linear interpolation algorithm, which applies to a system needing linear interpolation operation.

### BACKGROUND OF THE INVENTION

With maturation of communication market, communication-related IC is also persistently advancing, and more and more manufacturers increase the ratio of using computer graphics in small-size display systems. Due to prosperity of mobile electronic products, increasing running time of batteries can benefit a portable display device very much. Therefore, how to efficiently use batteries with image quality maintained stable is a challenge. Because of the superiority of realtime performance of the scan-conversion computer graphic system, the triangle-based rendering/shading technology has been the mainstream of the graphic subsystem of a realtime system.

The conventional pixel shading algorithm and scan-conversion algorithm do not treat the problem of power efficiency in algorithm level intentionally. Therefore, much power is wasted on unnecessary calculation.

Refer to FIG. 1 for a triangle-based graphic method in the current products, wherein the linear interpolations between the leading edge and trailing edge are repeated to find out the span of the current scanline. Then, linear interpolations are undertaken in the span to obtain the value of each dimension of Pi. Refer to FIG. 2, wherein the value of each dimension of Pᵢ(XᵢYᵢZᵢRᵢGᵢBᵢ) is obtained via performing linear interpolations between Pₙ(XₐYₐZₐRₐGₐBₐ) and P_{b}(X_{b}Y_{b}Z_{b}R_{b}G_{b}B_{b}).

As a hardware divider has a higher price, the conventional technology usually adopts an iterative division calculation, which shares a same adder/subtractor with accumulative calculations. Refer to FIG. 3 for a process of the conventional linear interpolation algorithm. A slope computation setup is performed firstly to obtain a difference term. Next, an iterative division is performed to obtain the slope. Then, the linear interpolations are completed with incremental addition calculations.

A personal computer often adopts a lower setup overhead graphic algorithm to promote graphic performance. However, the conventional graphic algorithm is hard to achieve power efficiency and graphic performance simultaneously.

Accordingly, the present invention proposes a precision-sensing linear interpolation algorithm, which can achieve image quality, graphic performance and power efficiency simultaneously. Further; the present invention has superior scalability and generic and can be applied to various systems for graphics or needing linear interpolation.

### SUMMARY OF THE INVENTION

The primary objective of the present invention is to provide a precision-sensing linear interpolation algorithm to modify the setup stage of the algorithm, shorten setup time, promote graphic performance and reduce power consumption in the setup stage.

Another objective of the present invention is to provide a precision-sensing linear interpolation algorithm having superior scalability and generic, wherein a masking method is used to decrease unnecessary bits and reduce the dynamic power consumption of the bit hardware.

The precision-sensing linear interpolation algorithm of the present invention comprises: (a) performing slope computation setup to obtain a difference term, (b) performing precision detection and setting the iteration number of iterative division calculations, (c) performing iterative division calculations to obtain the slopes, (d) removing bits unnecessary for the required precision with a bit-masking method, and (e) completing the linear interpolations with incremental addition calculations.

In the present invention, the precision detection is to obtain the difference between the theoretical quotient and the practical quotient, and the difference is used as a greater allowed tolerance of the system to reduce the iteration number of division calculations. The masking method sets the bits from the bit behind the greater allowed tolerance to the lowest bit to be 0 via an “AND 0” way.

The present invention is distinct from the conventional technology in that a precision detection is performed before iterative division calculations. Next, the iteration number of iterative division calculations is determined according to the required precision. After iterative division calculations, the bits in the decimal places redundant for the required precision are set to be zero with a bit mask. According to the precision required by a rendering, shading, or scan-conversion process of a triangle or span, the present invention adjust the precision the calculation needs to achieve and reduce the iteration number of calculations. Thus, the time occupied by iteration is reduced, and graphic performance is promoted. Further, the present invention utilizes a mask to set the bits redundant for the required precision to be 0. Thereby, the number of the switching activities of the circuit is reduced, and the dynamic power consumption is decreased, and the power efficiency is promoted.

### BRIEF DESCRIPTION OF THE DRAWINGS

FIG. 1 is a diagram schematically showing a conventional triangle-based graphic method.

FIG. 2 is a diagram schematically showing a linear interpolation operation.

FIG. 3 is a flowchart showing a conventional linear interpolation algorithm.

FIG. 4 is a flowchart showing the linear interpolation algorithm according to the present invention.

FIG. 5 is a flowchart showing the saving ratio in the setup stage of the improved algorithm

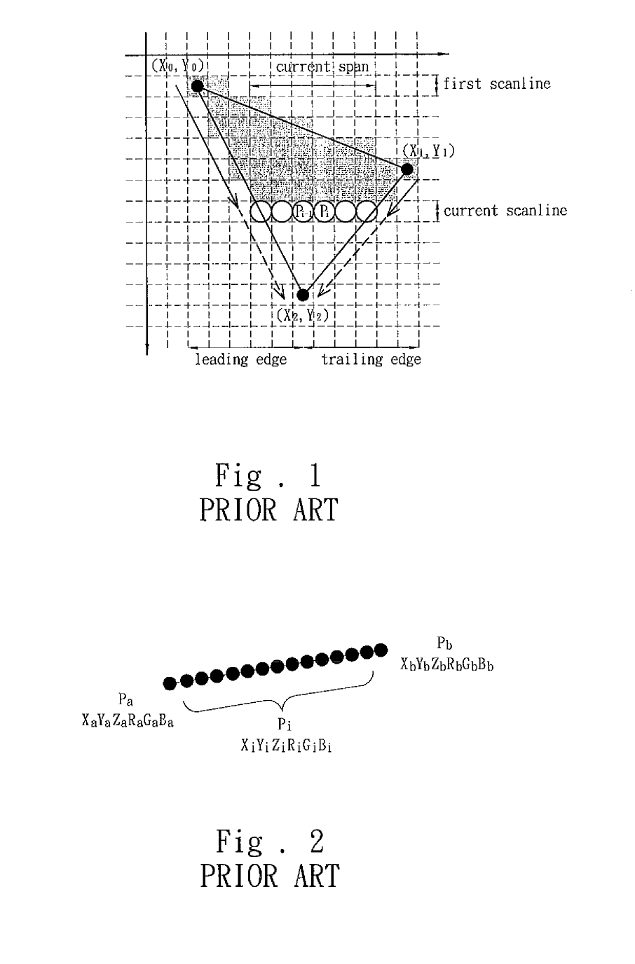

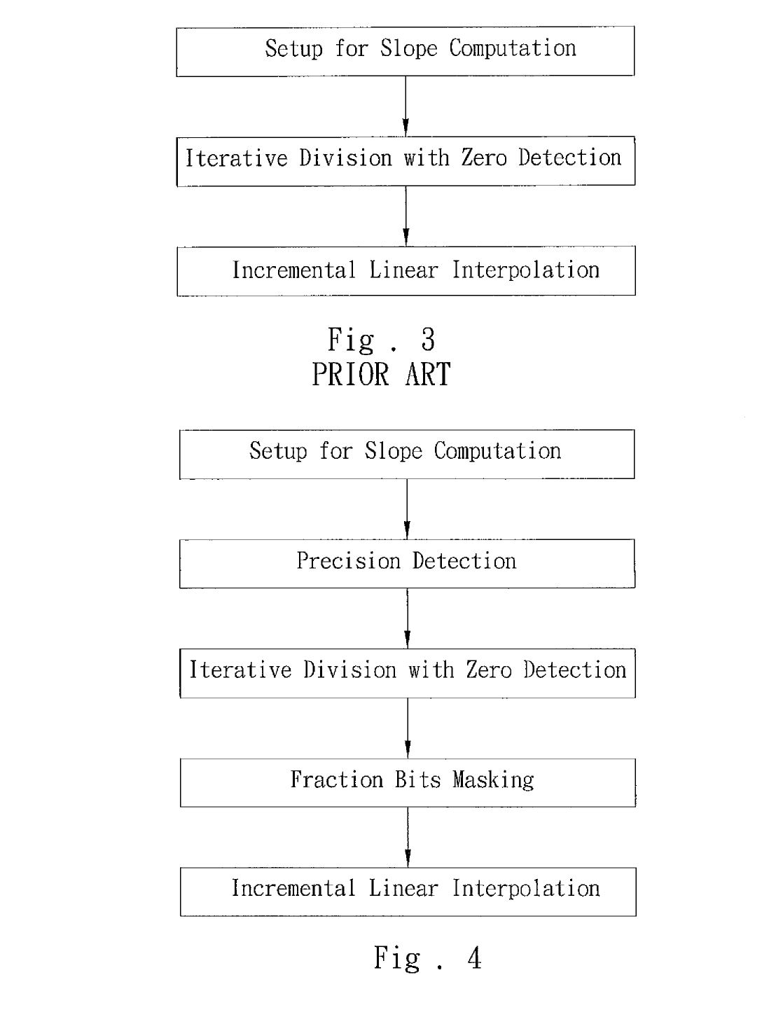

### DETAILED DESCRIPTION OF THE PREFERRED EMBODIMENTS

Below, the technical contents of the present invention are described in detail with the embodiments. However, it should be noted that the embodiments are only to exemplify the present invention but not to limit the scope of the present invention.

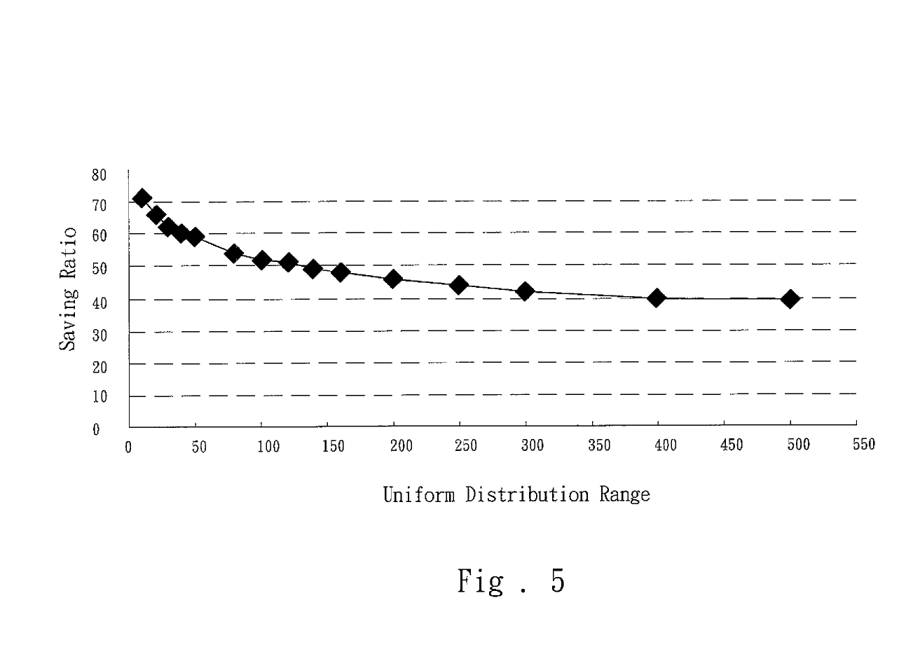

Refer to FIG. 4 a flowchart of the precision-sensing linear interpolation algorithm according to the present invention. The precision-sensing linear interpolation algorithm of the present invention comprises: (a) a slope computation setup is performed to obtain a difference term; (b) a precision detection is performed to set the iteration number of iterative division calculations via calculating the difference between the theoretical quotient and the practical quotient, wherein the difference is used as a greater allowed tolerance of the system to reduce the iteration number of division calculations; (c) iterative division calculations is performed to obtain the slopes; (d) the bits unnecessary for the required precision are removed with a bit-masking method, wherein the masking method sets the bits from the bit behind the greater allowed tolerance to the lowest bit to be 0 via an “AND 0” way; and (e) the linear interpolations are completed with incremental addition calculations.

The present invention is distinct from the conventional technology in that a precision detection is performed before iterative division calculations. Next, the iteration number of iterative division calculations is determined according to the required precision. After iterative division calculations, the bits in the decimal places unnecessary for the required precision are set to be zero with a bit mask. Via precision detection and bit masking, the present invention promotes algorithm efficiency and reduces dynamic power consumption.

Below is demonstrated the precision analysis of the present invention, which can achieve the same quality images as the conventional algorithm. For simplifying expressions, D denotes the dividend in slope computation, and S denotes the divisor, wherein {D, S} are integer; Q_{F} denotes the practical quotient of the division calculation using non-floating point number and limited bits; Q_{R} denotes the theoretic quotient of the correct quotient; E denotes the difference between the theoretic quotient and the practical quotient. The abovementioned variables meet Equations 1-5:

Q_{R}=Q_{F}+E (1)

2^{k}≦D<2^{k+1} (2)

2^{m}≦S<2^{m+1} (3)

D=Q_{R}·S=Q_{F}·S+ES (4)

E·S=D−Q_{F}·S (5)

In the scan-conversion process, the difference between the theoretic quotient Q_{R} and the practical quotient Q_{F} will be accumulated to E·S. Suppose the accumulated difference should be smaller than 2^{-r} (Equation 6) for different systems. Therefore, the quotient in practical calculation has to meet the inequality of Equation 7. Equation 8 means that the highest decimal place where error is allowed to appear in practical calculation is the (m+r+1)^{th} place after the decimal point. Usually, r=1. Thus, (m+2) decimal places are needed. Therefore, the iteration number of division calculations is k+2, which is the sum of k−m for the integer part and m+2 for the decimal fraction part. For RGB color dimensions, a greater error term E is allowed, and the iteration number of division calculations can be smaller

E·S<2^{-r} (6)

E<S⁻¹·2^{-r}=2^{-m-r} (7)

E=2^{-m-r-1}=2^{-(m+r+1)} (8)

After the approximate quotient is obtained, the bits from behind the (m+r+1)^{th} bit to the lowest bit are set to be 0 via the “AND 0” way. Thus, 1 will not appears in lower bits when incremental addition calculation is used to obtain Pᵢ shown in FIG. 2. Therefore, the number of switching activities is decreased in the scan-conversion process, and dynamic power consumption is reduced, and power efficiency is promoted.

Compared with the conventional algorithm, the present invention can reduce the time spent on the division calculations of the slopes of most spans. Refer to FIG. 5 for the saving ratio in the setup stage of the improved algorithm. For shorter average spans, the present invention can save as high as over 70% division calculation time. For longer average spans, the present invention can still save about 40% division calculation time.

Real systems are used to very the improved algorithm proposed by the present invention, and the results are shown in the table below. In comparison with the conventional algorithm, the present invention can upgrade power efficiency by from 42.6 to 76.5% in variation with the sizes of the triangles plotted by the improved algorithm,

| | | Power efficiency of | |
|---|---|---|---|
| | Conventional | the present | |
| Triangle size | power efficiency | invention | Improvement |
| (Pixels) | (MPixels/mJ) | (MPixels/mJ) | ratio |
| 255 | 3.333 | 1.912 | 42.6% |
| 171 | 3.161 | 1.741 | 44.9% |
| 128 | 3.065 | 1.618 | 47.2% |
| 102 | 2.973 | 1.513 | 49.1% |
| 85 | 2.879 | 1.420 | 50.7% |
| 51 | 2.314 | 1.151 | 50.3% |
| 25 | 1.949 | 0.764 | 60.8% |
| 10 | 1.226 | 0.441 | 64.0% |
| 5 | 0.844 | 0.276 | 67.3% |
| 2 | 0.664 | 0.156 | 76.5% |

Those described above are only the preferred embodiments to exemplify the present invention but not to limit the scope of the present invention. Any equivalent modification or variation according to the present invention is to be also included within the scope of the present invention.

What is claimed is:

1. A precision-sensing linear interpolation algorithm comprising following steps:
(a) performing slope computation setup to obtain a difference term;
(b) performing precision detection and setting the iteration number of iterative division calculations;
(c) performing iterative division calculations to obtain slopes;
(d) removing bits unnecessary for a required precision obtained in said precision detection with a bit-masking method; and
(e) completing linear interpolations with incremental addition calculations.

2. The precision-sensing linear interpolation algorithm according to claim 1, wherein said precision detection is to calculate difference between a theoretical quotient and a practical quotient, and said difference is used as a greater allowed tolerance of a system to reduce said iteration number of iterative division calculations.

3. The precision-sensing linear interpolation algorithm according to claim 2, wherein said bit-masking method sets bits from the bit behind said greater allowed tolerance to the lowest bit to be 0 via an “AND 0” way.
